(19) United States
(12) Patent Application Publication
(10) Pub. No.: US 2010/0110960 A1
(43) Pub. Date: May 6, 2010

(54) MBMS DATA TRANSMISSION AND RECEIVING IN PACKET BASED ON MOBILE COMMUNICATION SYSTEM

(76) Inventors: Jung-Im Kim, Daejon (KR); Jae-Heung Kim, Daejon (KR); Kyoung-Seok Lee, Daejon (KR); Byung-Han Ryu, Daejon (KR); Seung-Chan Bang, Daejon (KR)

Correspondence Address: STAAS & HALSEY LLP, SUITE 700, 1201 NEW YORK AVENUE, N.W., WASHINGTON, DC, 20005, US

(21) Appl. No.: 12/531,653

(22) PCT Filed: Mar. 21, 2008
(86) PCT No.: PCT/KR08/01590

§ 371 Date: Sep. 16, 2009

(30) Foreign Application Priority Data
Mar. 21, 2007 (KR) 10-2007-0027827

(51) Int. Cl. H04H 20/71

(52) U.S. Cl. 370/312

(57) ABSTRACT

Provided is a data transmission/reception method for simultaneously transmitting MBMS data from multiple cells through a HARQ method by allocating a shared feedback channel to user equipments of each cell and, when there is an error in the transmitted MBMS data, reporting feedback on a cell basis. The method for transmitting identical MBMS data from multiple cells to user equipments includes: a) transmitting control information including information on a service group identifier for the MBMS data and on a cell-specific shared feedback channel shared by user equipments of a cell to the user equipments through a control channel; b) transmitting MBMS data to the user equipments; c) when an acknowledgement is received through the shared feedback channel from at least one user equipment, transmitting radio resource information of retransmission data to the user equipments through a downlink control channel; and d) transmitting the retransmission data to the user equipments.

### TECHNICAL FIELD

The present invention relates to a transmission technology of Multimedia Broadcast Multicast Service (MBMS) data in a packet-based mobile communication system; and, more particularly, to a method for simultaneously transmitting MBMS data from multiple cells by using Hybrid Automatic Repeat reQuest (HARQ) technology in a packet-based mobile communication system, and a reception method thereof.

### BACKGROUND ART

A Multimedia Broadcast Multicast Service (MBMS) is a service providing broadcast and multicast services to user equipments through a mobile communication network. Typically, MBMS services transmit data from multiple cells simultaneously in order to combine data transmitted from the cells and thereby reduce an error rate.

Signals passing through a typical radio channel may have diverse kinds of errors occurring due to fading of the radio channel and interference signals. Error correcting methods in mobile communication systems largely include an Automatic Repeat Request (ARQ), forward error correction (FEC), and Hybrid Automatic Repeat reQuest (HARQ) which combines the ARQ and FEC.

Both ARQ and HARQ methods transmits data based on a premise that there is on receiver, and the receiver acknowledges whether the data are received successfully or not through a feedback channel. According to the ARQ method, since a plurality of data packets are received and the reception of the data packets is acknowledged through a feedback channel, it takes a long time delay.

The HARQ method is a combined method of the ARQ and the FEC for improved error correction capability. In other words, the HARQ method does not abandon previous data packets where errors occur and inputs them to an error correcting decoder to improve the error correction capability, when data packets retransmitted in the ARQ method are decoded. Typically, an error occurs in part of data packets. Therefore, if the data packets with an error are not abandoned and inputted to a decoder, the error correction capability is improved. To use a forward error correction code of a physical layer, the amount of data to be stored increases considerably. To reduce the amount of data to be stored, whether a data error occurs is reported rapidly through a feedback channel and retransmission is executed quickly in the HARQ method.

The HARQ method is largely divided into an Incremental Redundancy (IR) method and a Chase Combining (CC) method. According to the IR method, new parity bits are added to retransmission data in order to acquire more gain of channel coding when data are retransmitted. According to the CC method, retransmission data are the same as the data previously transmitted. The IR method is superior in the performance to the CC method, but it has a shortcoming that the complexity of a receiver increases. Although the CC method is superior to the IR method from the perspective of receiver complexity, it has a shortcoming that its performance is inferior to that of the IR method.

Broadcast services such as Multimedia Broadcast Multicast Service (MBMS) employ a method of transmitting data from multiple cells in a 3^{rd} Generation Partnership Project (3GPP) Wideband Code Division Multiple Access (WCDMA) Release-6 system. However, a WCDMA system is an asynchronous system. Thus, even if the multiple cells transmit data simultaneously, the data are not received simultaneously at a user equipment. Accordingly, the user equipment should execute a complicated process of independently receiving signals transmitted from each of the cells and combine the data from the cells. The 3GPP Specification specifies to execute soft combining or selective combining to combine the signals transmitted from multiple cells.

Meanwhile, when channel conditions degrade and there are many errors in received data in the WCDMA system, the ARQ or HARQ are not used, and a method of retransmitting data in an application layer is used. The method of repetition data repeatedly is executed without any feedback about a radio channel. Therefore, there is a problem in that data are transmitted repeatedly even through the data do not have to be retransmitted. This causes wasteful consumption of radio resources.

3GPP Long Term Evolution (LTE), which is under standardization at present, is working on a method of transmitting MBMS data of the same contents from multiple cells and transmitting MBMS data unique to a cell from the cell only in order to provide the MBMS services in multiple cells. The method of transmitting the same MBMS data from the multiple cells provides stronger reception signals to a user equipment than a method of transmitting MBMS data from a single cell to thereby reduce an error rate. However, the method of transmitting the same MBMS data from the multiple cells does not always provide a low error rate to user equipments in the entire cell coverage of the multiple cells. To be specific, user equipments in cell boundary of a cell whose radius is long and user equipments of a cell not in the center of the multiple cells but on the outskirt of the multiple cells can hardly expect such low error rate. On the other hand, those user equipments of cells with a short cell coverage radius and those of a cell at the center of the multiple cells can expect the low error rate. Therefore, it is required to develop a method for reducing a packet error rate when data are transmitted from multiple cells and a radio channel environment is poor.

### DISCLOSURE

### Technical Problem

An embodiment of the present invention, which is devised to overcome the problems of the conventional technologies, is directed to providing a data transmission/reception method for simultaneously transmitting Multimedia Broadcast Multicast Service (MBMS) data from multiple cells through a Hybrid Automatic Repeat reQuest (HARQ) method in a packet-based mobile communication system by allocating a shared feedback channel to user equipments of each cell and, when there is an error in the transmitted MBMS data, reporting feedback on a cell basis.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for transmitting identical Multimedia Broadcast Multicast Service (MBMS) data from multiple cells to user equipments in a packet-based mobile communication system, which includes: a) transmitting control information including information on a service group identifier for the MBMS data and on a cell-specific shared feedback channel shared by user equipments of a cell to the user equipments through a control channel; b) transmitting MBMS data packets to the user equipments; c) when an acknowledgement is received through the shared feedback channel from at least any one user equipment, transmitting radio resource information of retransmission data to the user equipments through a downlink control channel; and d) transmitting the retransmission data to the user equipments.

In accordance with another aspect of the present invention, there is provided a method for transmitting identical MBMS data from multiple cells to user equipments in a packet-based mobile communication system and receiving the MBMS data in the user equipments, which includes: a) receiving control information including information on a service group identifier for the MBMS data and on a cell-specific shared feedback channel shared by user equipments of a cell from a base station through a control channel; b) receiving MBMS data packets; c) transmitting a Cyclic Redundancy Check (CRC) result obtained by executing CRC onto the received MBMS data through the shared feedback channel; d) receiving radio resource position information of retransmission data through a downlink control channel; and e) receiving the retransmission data.

Each user equipments receiving an MBMS service is assigned with a Cell Radio Network Temporary Identifier (C-RNTI), which is a cell-specific MBMS service identifier for an MBMS service, to receive downlink control signals.

Also, in case of a hybrid cell where a base station provides a unicast service and an MBMS service, some resources of unicast are allocated and used as resources for retransmission of the MBMS data.

Also, according to the present invention, a base station of each cell informs user equipments of position of an uplink shared feedback channel shared by the user equipments of the cell and time when data can be transmitted through a control channel.

### Advantageous Effects

The present invention described above can improve forward error correction efficiency by using a Hybrid

Automatic Repeat reQuest (HARQ) method, while minimizing the use of resources when Multimedia Broadcast Multicast Service (MBMS) data are transmitted form multiple cells to a plurality of user equipments in a packet-based Long Term Evolution (LTE) mobile communication system. Also, the present invention can reduce the amount of power consumption of user equipments operating in a power-saving mode by informing the user equipments of time when data transmission through downlink control channel is available. Moreover, the present invention can minimize inter-cell interference caused as many user equipments use a feedback channel to give a feedback chance to those user equipments maintaining uplink sync prior to the other user equipments not maintaining uplink sync.

### BRIEF DESCRIPTION OF THE DRAWINGS

FIG. 1 is a block view illustrating a Multimedia Broadcast Multicast Service (MBMS) service network to which the present invention is applied.

FIG. 2 is a detailed block view showing the MBMS service network of FIG. 1.

FIG. 3 is a flowchart describing MBMS data transmission in accordance with an embodiment of the present invention.

FIG. 4 illustrates examples of feedback channels in accordance with an embodiment of the present invention.

FIG. 5 illustrates a process of allocating feedback channels and retransmitting data in accordance with an embodiment of the present invention.

### BEST MODE FOR THE INVENTION

The advantages, features and aspects of the invention will become apparent from the following description of the embodiments with reference to the accompanying drawings, which is set forth hereinafter. Also, when it is considered that detailed description on a related art may obscure a point of the present invention, the description will not be provided herein. Hereinafter, specific embodiments of the present invention will be described with reference to the accompanying drawings.

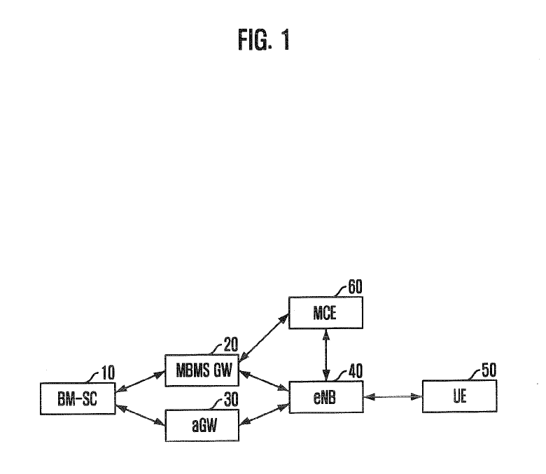

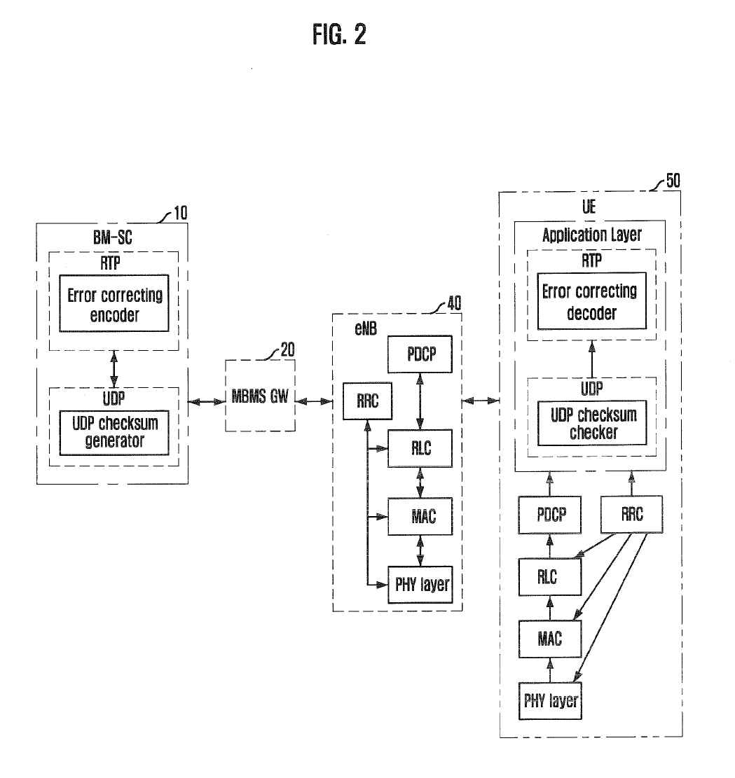

FIGS. 1 and 2 are block views illustrating a structure of a network for providing a Multimedia Broadcast Multicast Service (MBMS) service to which the present invention is applied. FIGS. 1 and 2 exemplarily show a 3GPP LTE UMTS Terrestrial Radio Access Network (UTRAN) system.

The network for providing the MBMS service includes a broadcast and multicast service center (BM-SC) 10 for providing the MBMS service, an MBMS gateway (GW) 20, which is a gateway dedicated to an MBMS service, an access gateway (aGW) 30 for supporting a unicast service, which is not an MBMS service, and a base station (eNB) 40. Also, the network for providing the MBMS service includes an MBMS coordination entity (MCE) 60 for managing the base stations of the multiple cells and scheduling transmission of MBMS packets to transmit MBMS data through multiple cells. To be specific, the MCE 60 connects the MBMS gateway 20 and the base station 40, manages the base stations of the cells, and executes scheduling to transmit MBMS data through the cells.

The present embodiment presents the MBMS gateway 20 and the access gateway 30 in separate forms, but it is possible to form them not separated but integrated.

Generally, the BM-SC 10 includes a Real Time Protocol (RTP), which is a real-time processing protocol, and a User Datagram Protocol (UDP). The RTP includes an error correcting encoder, and the UDP includes a UDP checksum generator.

The radio interface protocol of the base station and a user equipment 50 horizontally includes a physical layer, a data link layer and a network layer, and vertically includes a user plane for transmitting data information and a control plane for transmitting control signals. The protocol layers may be divided into a first layer (L1), a second layer (L2), and a third layer (L3) based on the lower three layers of an Open System Interconnection (OSI) reference model, which is widely known as a communication system.

The first layer, which is a physical layer, provides an information transfer service to an upper layer through a physical layer. The physical layer is connected to a Medium Access Control (MAC) layer, which is in the upper part of the physical layer, through a transport channel. Data of the MAC layer and the physical layer are transported through the transport channel.

The MAC layer of the second layer provides a service to an upper layer, which is a Radio Link Control (RLC) layer, through a logical channel. The RLC layer of the second layer supports transmission of reliable data, and segments or concatenates RLC Service Data Units (SDU) coming down from an upper layer.

The Radio Resource Control (RRC) layer disposed in the lowest part of the third layer is defined only in the control plane. The RRC layer is in charge of controlling logical channels, transport channels, and physical channels in relation to configuration, re-configuration and release of radio bearers.

Meanwhile, Packet Data Convergence Protocol (PDCP) for compression and expansion of a packet header may be mounted on top of the RLC layer.

MBMS data pass through the MBMS gateway 20 and enter the user equipment 50 through the base station 40. The physical layer of the user equipment 50 receives the data transmitted through the radio channel, decodes the received data, and executes Cyclic Redundancy Check (CRC).

The physical layer of the user equipment 50 decides whether there is an error in received data packets by performing channel decoding and executes CRC, and transmits a CRC result and data packets except CRC bits to an RLC layer through an MAC layer.

When a provided service is not an MBMS service, a 3GPP LTE-based system uses a Dedicated Control Channel (DCCH) and a Dedicated Traffic Channel (DTCH) as logical channels. Control signals are transmitted through the dedicated control channel, and data are transmitted through the dedicated traffic channel. In the mean time, the MBMS service employs a Multicast Control Channel (MCCH) and an MBMS Traffic Channel (MTCH) as logical channels. Control signals are transmitted through the multicast control channel, which is an MBMS-dedicated control channel, and the data are transmitted through the MBMS traffic channel, which is an MBMS-dedicated data channel.

A packet-based cellular system informs of scheduling information on time and frequency that a user equipment transmits/received data through downlink control signals, which are L1/L2 control signals. Downlink is a link through which signals are transmitted from a base station to a user equipment.

Generally, when L1/L2 control signals are received, downlink data are transmitted together. Information on multiple user equipments can be simultaneously transmitted through upon receipt of downlink control signals. The space of control signals assigned to the user equipment is discriminated as an identifier of the user equipment 50. For the user equipment 50 to receive downlink control signals, the user equipment 50 should be aware of an identifier assigned thereto first. The identifier is called a Cell-Radio Network Temporary Identifier (C-RNTI). The C-RNTI may be assigned to only one user equipment or it may be assigned as a group identifier for a plurality of user equipments.

When a service provided in the packet-based cellular system is not an MBMS service but a unicast service, the HARQ method is applied. To be specific, a base station transmits downlink data to a user equipment, and the user equipment receives the data and reports whether the data are successfully received or not through an uplink feedback channel. Herein, the base station informs user equipments of radio resources to be used as a feedback channel at the moment when the service begins to be provided. The position of the feedback channel may be decided implicatively according to what radio resources are used to transmit the L1/L2 control signals to the user equipment. Generally, the user equipment transmits feedback by using a feedback channel decided and given in a predetermined time after reception of data.

Herein, the position of the feedback channel may be static or dynamic. When the feedback channel is static, the user equipment uses the resources decided by the base station at the initial stage of the service as a feedback channel. When the feedback channel is dynamic and the position of the feedback channel is changed and the user equipment need to recognize the position of the changed feedback channel, the base station informs the user equipment of information on the feedback channel.

When data are successfully received without an error, the user equipment transmits a positive acknowledgement (ACK) to the base station through a feedback channel. When data are not successfully received, the user equipment transmits a negative acknowledgement (NACK) to the base station through a feedback channel.

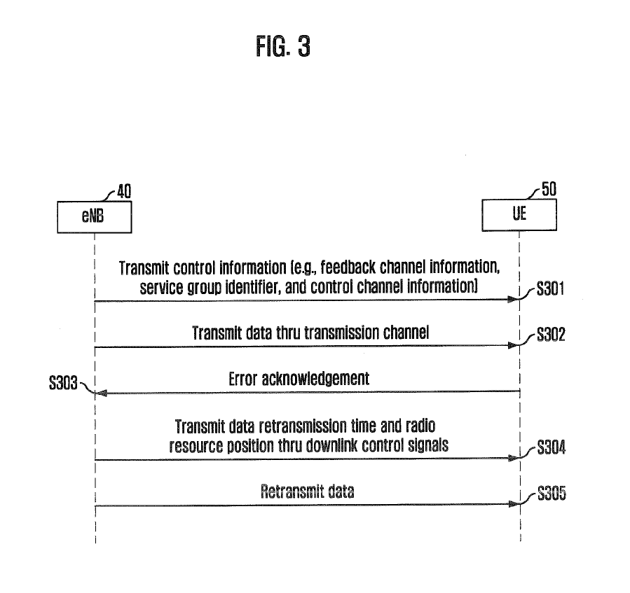

FIG. 3 is a flowchart describing a process of transmitting MBMS data packets in a packet-based cellular system in accordance with an embodiment of the present invention.

The base station transmitting MBMS data packets may be divided into a base station for transmitting unicast service data and MBMS service data and a base station for transmitting only MBMS service data. Herein, the base station transmitting unicast service data and MBMS service data is referred to as a base station of a hybrid cell, whereas a cell transmitting only MBMS service data is referred to as a dedicated cell. In case of the hybrid cell, the base station transmits unicast service data and MBMS service data through a given one frequency band, and the unicast service data and the MBMS service data are transmitted separately according to time. In case of a dedicated cell, the base station transmits only the MBMS service data through one frequency band.

According to the present invention, when MBMS service data of the same content are simultaneously transmitted from multiple cells and an error is detected after the user equipments execute CRC onto received packets, the error is reported through a shared feedback channel allocated to all user equipments in the same cell. The base station of the cell retransmits the MBMS data packets with the error. Herein, the MBMS data packets retransmitted due to the error occurrence can be transmitted by using some resources of unicast. In short, the base station uses some resources for the retransmission of the MBMS data packets when a unicast service is provided.

When the repetition is executed without feedback, the base station should retransmit all data. Thus, there is a problem in that much radio resources are wastefully consumed because data without an error are also retransmitted. On the other hand, as suggested in the present invention, when the error is reported through a feedback channel and only data with an error are retransmitted, it is possible to save radio resources from being wastefully consumed.

According to the present invention, the base station of each cell informs all user equipments in the cell of the position of the uplink shared feedback channel that all the user equipments share and time information when signals can be transmitted through L1/L2 control channels. The base station decides the position of the shared feedback channel and the time information when signals are transmitted through the control channels, and it informs information on the feedback channel through an MBMS control channel from when an MBMS service begins to when the MBMS service ends. When time information when transmission through a control channel is available is informed through the MBMS control channel, there is an advantage that the power consumption of a user equipment without RRC connection can be minimized.

When the base station is informed through the shared feedback channel that there is an error in the received packets, the base station informs the user equipment of the position information and the time information when retransmission begins through the L1/L2 control channels. In the present invention, a C-RNTI is assigned to each MBMS service, and the user equipments receive signals through the L1/L2 control channels by using the assigned C-RNTI.

A user equipment reports the occurrence of an error through the shared feedback channel only when an error occurs in received packets. The user equipment should be able to receive the MBMS service both when it is in connection with RRC and when it is in disconnection with RRC. In general, a user equipment in disconnection with RRC does not maintain uplink sync, and a user equipment in connection with RRC may or may not maintain uplink sync.

In the present invention, when the user equipment maintaining uplink sync transmits signals to the base station through a feedback channel, the base station does not transmit uplink information of the user equipment in order to receive the signals transmitted from the user equipment through the feedback channel. In case of the user equipment not maintaining the uplink sync, however, sync information of the user equipment is transmitted to the base station along with the signals transmitted through the feedback channel.

According to a method different from the present invention, when a user equipment does not have uplink sync, the user equipment and the base station transmit sync information at regular time intervals. Generally, such method has a shortcoming that radio resources are consumed wastefully because there are more time when sync maintenance information is needed than when the feedback channel of the user equipment is needed.

According to the present invention, user equipments maintaining uplink sync have priority chances for using the feedback channel, and user equipments not maintaining uplink sync transmit an error report through the feedback channel only when the user equipments with uplink sync do not make an error report through the feedback channel.

The user equipments not maintaining uplink sync use more radio resources than the user equipments maintaining uplink sync, because the sync information of the user equipments are included. Thus, when a plurality of user equipments simultaneously transmit signals through the feedback channel, the feedback channel acts as an interference over adjacent cells. To solve this problem, the present invention reduces the interference over adjacent cells by having the user equipments not maintaining uplink sync transmit signals through the feedback channel only when the user equipments maintaining uplink sync do not transmit signals through the feedback channel.

For this, the user equipments not maintaining uplink sync reads the L1/L2 control channels within a given time, and checks whether the user equipments maintaining uplink sync transmit signals through the feedback channel. To minimize the time for reading the L1/L2 control channels, the present invention employs a synchronous HARQ method in which the time for retransmitting data is uniform. When user equipments receive the signals transmitted through the L1/L2 control channels within the given time, the power consumption of the user equipments is reduced.

Also, when the user equipments maintain uplink sync, the uplink control channel is used as a feedback channel in the present invention, and when the user equipments do not maintain uplink sync, a random access channel (RACH) is used as a feedback channel.

Hereinafter, the present invention will be described by referring to FIG. 3 and up. Referring to FIG. 3, at step S301, a base station transmits control information to user equipments through a dedicated control channel, e.g., MCCH, and a transport channel mapped to the dedicated control channel in the initial stage of an MBMS service. A logical channel MCCH and a transport channel mapped to the logical channel MCCH may be used to transmit MBMS data packets from multiple user equipments. The control information may include scheduling information on data transmission, HARQ-related information, a group identifier for the MBMS service, feedback channel information, and time information when signals can be transmitted through the control channel.

Such control information should be received by all the user equipments in common. Therefore, the dedicated channel, e.g., MCCH, should repeatedly transmit data at a regular time period so that the user equipments can receive the MBMS service at any time. In the present invention, the base station repeatedly transmits signals through the dedicated control channel, which is MCCH, at a regular time period.

According to the present invention, the user equipments of the same cell share the feedback channel. This is referred to as a shared feedback channel. In this case, the base station may have one or more shared feedback channels. When the base station has multiple shared feedback channels, the shared feedback channels may be variably allocated according to the number of user equipments and a radio channel environment. The feedback channels are managed by the base station. The base station transmits information on the feedback channels to the user equipments in the initial stage of the MBMS service. When the feedback channels need to be modified, the base station transmits feedback channel modification information to the user equipments. Also, the base station informs the user equipments in a cell of time information when signal transmission through L1/L2 control channels is available in the present invention.

A group identifier for the MBMS service may be a C-RNTI which is reserved by the base station. In other words, the base station assigns C-RNTI in advance for the MBMS service so that the user equipments can receive downlink L1/L2 control signals for the MBMS service by using the assigned C-RNTI.

When a system supports both IR and CC methods, HARQ-related information includes which method is to be used and how to use the method, and the maximum retransmission times. When either IR or CC is selected, the HARQ-related information does not include the information on which method is to be used.

At step S302, the base station transmits control information to the user equipments and transmits MBMS data packets through a transport channel.

When CRC is executed onto the data packets transmitted from the base station in the physical layer of a user equipment and a CRC error occurs, at step S303, a negative acknowledgement (NACK) is transmitted to the base station through a shared feedback channel allocated by the base station. The operation of the user equipment will be described in detail hereinafter.

Generally, all the user equipments should be able to receive the MBMS service in both RRC connection state and RRC disconnection state. The RRC layer of the base station assigns each user equipment in the RRC connection with a unique identifier corresponding to a cell. The user equipment in the RRC connection may or may not maintain uplink sync. User equipments in the RRC disconnection do not have a cell-specific identifier assigned thereto, and they do not maintain uplink sync.

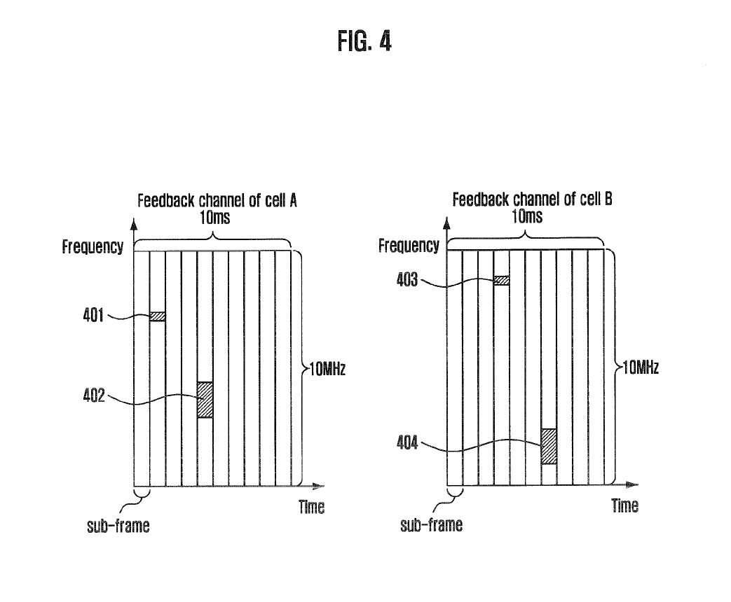

FIG. 4 illustrates examples of feedback channels in accordance with an embodiment of the present invention. As illustrated in FIG. 4, when both cell A and cell B simultaneously execute HARQ onto MBMS data packets, the base station may allocate two channels having different sizes to each other in the state maintaining uplink sync and the state not maintaining uplink sync as feedback channels. Herein, when a user equipment maintains uplink sync, an uplink control channel is used as a shared feedback channel. When a user equipment does not maintain uplink sync, a random access channel is used as a shared feedback channel.

In both cell A and cell B, the feedback channel of the user equipment maintaining uplink sync is allocated temporally prior to the feedback channel of the user equipment not maintaining uplink sync. The reference numerals 401 and 403 are feedback channels allocated to the user equipment maintaining uplink sync, whereas the reference numerals 402 and 404 are feedback channels allocated to the user equipment not maintaining uplink sync. In the cell A and the cell B, feedback channels are allocated to different spaces in the respect of time and frequency. For example, the cell A and the cell B allocate one or two subcarriers for 1 millisecond, which is one sub-frame, as the size of the uplink feedback channel in the state maintaining uplink sync, and allocate 1.25 MHz for 1 millisecond in the state not maintaining uplink sync.

The size of the feedback channel is different according to whether or not the user equipment is maintaining uplink sync. This is because when the user equipment acquires sync for transmitting uplink signals through the feedback channel, all it has to transmit is content data, which requires a small feedback channel. However, when the user equipment does not acquire the sync for transmitting uplink signals through the feedback channel, it has to transmit sync information along with the content data to the base station.

Referring to FIG. 4, a feedback channel 401 for the user equipments maintaining uplink sync is allocated prior to a feedback channel 402 for the user equipments not maintaining uplink sync. According to the present invention, the base station informs user equipments of the time when downlink control signals can be transmitted so that user equipments in the RRC disconnection state saves power consumption. If the user equipments do not know when downlink control signals should be transmitted, they should continue to decode downlink control signals, which increases power consumption of the user equipments.

Meanwhile, when errors are simultaneously detected in the reception data transmitted from the user equipments maintaining uplink sync and the user equipments not maintaining uplink sync, only the user equipments maintaining uplink sync transmit data through the feedback channel in the present invention. The base station receives the data transmitted through the feedback channel, and transmits downlink control signals and data. The user equipments maintaining uplink sync and the user equipments not maintaining uplink sync receive the retransmission data.

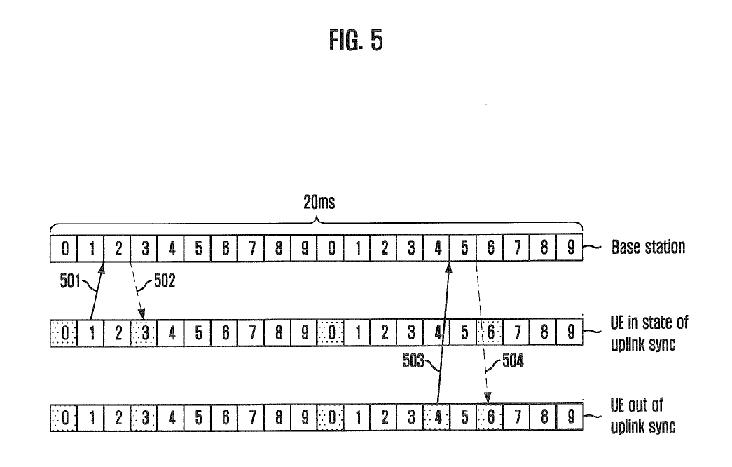

To be specific, as illustrated in FIG. 5, the base station assigns its second sub-frame to a user equipment maintaining uplink sync for 10 milliseconds (see 401) so that the user equipment maintaining uplink sync transmit data through a feedback channel. Also, the base station assigns its fifth sub-frame to a user equipment not maintaining uplink sync (see 503) so that the user equipment not maintaining uplink sync transmit data through a feedback channel. According to the present invention, the user equipments of the two states are assigned with an opportunity for transmitting data through the feedback channel. When both user equipment maintaining uplink sync and user equipment not maintaining uplink sync detect errors in the received data, the user equipment in the state of maintaining uplink sync first transmits NACK to the base station through the feedback channel (see 501). Both user equipments receive downlink control signals from the base station in the third sub-frame (see 502). Each user equipment checks whether data are retransmitted in the third sub-frame, and receives the retransmission data. Herein, when the user equipment not maintaining uplink sync receives the retransmission data, it does not transmit data allocated to the fifth sub-frame through the feedback channel (see 503).

When the base station receives NACK from a user equipment through the feedback channel, it informs user equipments of retransmission time when retransmission data with an error are transmitted and position information of radio resources in step S304. Subsequently, the base station transmits retransmission data to the user equipments through a transport channel in step S305.

The user equipment searches for the position of downlink L1/L2 control signals allocated to MBMS data by using an MBMS service group identifier, e.g., C-RNTI, which is assigned by the base station in advance and transmitted through a dedicated control channel. Since the user equipment knows the time when the downlink control signals are transmitted, it can decode the downlink control signals at corresponding time.

The user equipment receives the retransmission data transmitted through the transport channel based on the transmission time information of the retransmission data and the radio resource position information, which are acquired through the downlink control signals, and executes CRC on the received retransmission data. The user equipment may repeat the aforementioned process of transmitting NACK through the feedback channel according to the CRC result in predetermined times.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The present invention is used to simultaneously transmit MBMS data from multiple cells based on HARQ technology in a packet-based mobile communication system.

1. A method for transmitting identical Multimedia Broadcast Multicast Service (MBMS) data from multiple cells to user equipments in a packet-based mobile communication system, comprising:
transmitting control information including information on a service group identifier for the MBMS data and on a cell-specific shared feedback channel shared by user equipments of a cell to the user equipments through a control channel;
transmitting MBMS data packets to the user equipments;
when an acknowledgement is received through the shared feedback channel from at least any one user equipment, transmitting radio resource information of retransmission data to the user equipments through a downlink control channel; and
transmitting the retransmission data to the user equipments.

2. The method of claim 1, wherein the retransmission data are transmitted using unicast resources in the transmitting the retransmission data.

3. The method of claim 1, wherein the control information includes time information indicating when transmission through the downlink control channel is available in the transmitting control information.

4. The method of claim 3, wherein the shared feedback channel information and the time information indicating when transmission through the downlink control channel is available are periodically transmitted to the user equipments.

5. The method of claim 3, wherein the shared feedback channel is managed by a base station of each cell, and different time and subcarriers are allocated to each base station.

6. The method of claim 3, wherein time and frequency positions of the shared feedback channel are allocated differently according to whether a user equipment maintains uplink sync.

7. The method of claim 6, wherein a shared feedback channel for a user equipment maintaining uplink sync is allocated temporally prior to a user equipment not maintaining uplink sync.

8. The method of claim 7, wherein the user equipment maintaining uplink sync uses an uplink control as the shared feedback channel, and the user equipment not maintaining uplink sync uses a random access channel as the shared feedback channel.

9. A method for transmitting identical Multimedia Broadcast Multicast Service (MBMS) data from multiple cells to user equipments in a packet-based mobile communication system and receiving the MBMS data in the user equipments, comprising:
receiving control information including information on a service group identifier for the MBMS data and on a cell-specific shared feedback channel shared by user equipments of a cell from a base station through a control channel;)
receiving MBMS data packets;
transmitting a Cyclic Redundancy Check (CRC) result obtained by executing CRC onto the received MBMS data through the shared feedback channel;
receiving radio resource position information of retransmission data through a downlink control channel; and
receiving the retransmission data.

10. The method of claim 9, wherein the retransmission data are received using unicast resources in the receiving the retransmission data.

11. The method of claim 9, wherein the control information includes time information indicating when transmission through the downlink control channel is available in the receiving control information.

12. The method of claim 11, wherein the shared feedback channel information and the time information indicating when transmission through the downlink control channel is available are periodically received.

13. The method of claim 11, wherein the shared feedback channel is managed by a base station of each cell, and different time and subcarriers are allocated to each base station.

14. The method of claim 11, wherein time and frequency positions of the shared feedback channel are allocated differently according to whether a user equipment maintains uplink sync.

15. The method of claim 14, wherein in the transmitting a Cyclic Redundancy Check (CRC) result, only when an error is detected in the received packets after the CRC, an acknowledgement is transmitted through the shared feedback channel.

16. The method of claim 14, wherein in the receiving radio resource position information of retransmission data, when data received through the downlink control channel are decoded in a state that no acknowledgement is transmitted through the shared feedback channel and the decoded data includes radio resource position related to the retransmission data, no acknowledgement is transmitted through the shared feedback channel.
